(19) United States
(12) Patent Application Publication
(10) Pub. No.: US 2003/0046234 A1
(43) Pub. Date: Mar. 6, 2003

(54) Automatic money receiving and paying machine

(76) Inventor: Masato Takadachi, Owariasahi (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/196,283

(22) Filed: Jul. 17, 2002

(30) Foreign Application Priority Data
Aug. 28, 2001 (JP) 2001-258307

(51) Int. Cl. G06F 17/60

(52) U.S. Cl. 705/43

(57) ABSTRACT

An automatic money receiving and paying machine permits the user to deposit and withdraw money of a plurality of currencies in a plurality of accounts for improving convenience. An ATM can read a plurality of candidate accounts with which the user can deposit and withdraw money by a magnetic card which records a plurality of account numbers. The ATM communicates with a host computer to present the user with information such as an interest rate, the balance and the like for each candidate account. Conversion rates are presented to the user with the foregoing information to assist the user to deposit or withdraw money of a currency unit which is different from that designated to a candidate account. The user can select an account and a currency unit using the presented information for determination.

### BACKGROUND OF THE INVENTION

The present invention relates to an automatic money receiving and paying machine for receiving and paying money from an account in response to a manipulation of a user, and more particularly, to an automatic money receiving and paying machine which can support a plurality of accounts or currency units.

In financial institutions and the like, automatic teller machines (hereinafter called the “ATM”) are used for receiving and paying money from and to customers. In recent years, there has been proposed an ATM which can support a plurality of currency units. For example, a technique described in JP-A-10-3564 assumes a customer having an account dedicated to a currency unit different from yen and permits the customer to deposit and withdraw money in units of yens by converting an amount of money in units of yens inputted by the customer to the currency unit corresponding to the account.

As another technique, there has been also proposed an ATM which can simultaneously support a plurality of accounts. In this technique, a user who has three types of accounts associated with currency units, for example, renminbi, Hong Kong dollar, U.S. dollar and the like is given a cash card which records account numbers of these three types of accounts, and the like. The user, when using an ATM, can deposit and withdraw money in a desired currency unit corresponding to each account by selecting as appropriate any of the three types of accounts recorded on the card.

### SUMMARY OF THE INVENTION

However, conventional ATMs have failed to permit the user to flexibly select a currency unit in which the user can withdraw money from an ATM. In the former technique (described in JP-A-10-3564), an available currency unit of money withdrawn from an ATM is limited, for example, to “yen” or the like, depending on the country in which the ATM is installed. In the latter technique, while the user can withdraw money in a plurality of currency units by selecting an appropriate account, the ATM cannot convert one currency unit to another for payment, such as payment of U.S. dollar from an account which is designated renminbi. Therefore, even when there is a sufficient balance in a different account, the user experiences an inconvenience that the user cannot withdraw a desired amount of money in U.S. dollar if a sufficient balance does not remain in an account of U.S. dollar.

On the other hand, the conventional ATM which can support a plurality of accounts merely provides less than satisfactory convenience in selecting an account. A selection of an account from a plurality of accounts depends on a currency unit in which the user is to withdraw money. When no restriction is imposed on currency units, or when a user has a plurality of accounts in a common currency unit, it is difficult for the user to determine profits and losses associated with a selection of an account.

As can be seen from the foregoing, the conventional ATMs are not sufficiently convenient in receipt and payment of money in a plurality of currency units with a plurality of accounts. An improvement on such convenience has been particularly needed from the economic background which involves requirements for deposit and withdrawal of money in a plurality of currency units associated from the globalization of economy, and an increased number of users who properly use a plurality of accounts depending on particular purposes and the like. The present invention has been made to meet such requirements, and it is an object of the invention to improve the convenience to the user in depositing and withdrawing money in a plurality of currency units with a plurality of accounts.

To solve at least some of the foregoing problems, in particular, the present invention provides an automatic money receiving and paying machine for receiving and paying money to and from an account in response to a manipulation of a user, wherein a plurality of accounts can be handled, and supporting information is presented to the user for helping the user select an account from a plurality of accounts. For this purpose, the automatic money receiving and paying machine of the present invention includes, in a first configuration, an account input unit, a supporting information presenting unit, a selection instruction input unit, an amount input unit, and an money receipt/payment unit.

Other objects, features and advantages of the invention will become apparent from the following description of the embodiments of the invention taken in conjunction with the accompanying drawings.

### BRIEF DESCRIPTION OF THE DRAWINGS

FIG. 1 is an explanatory diagram generally illustrating the configuration of an automatic teller machine which embodies the present invention;

FIG. 2 is an explanatory diagram illustrating functional blocks of a control unit 120;

FIG. 3 is a flow chart of payment processing;

FIG. 4 is a flow chart of money receipt processing; and

FIG. 5 is a flow chart of transfer processing in a second embodiment.

### DESCRIPTION OF THE EMBODIMENTS

In the following, the present invention will be described in connection with some embodiments thereof.

A. First Embodiment:

A1. General Configuration:

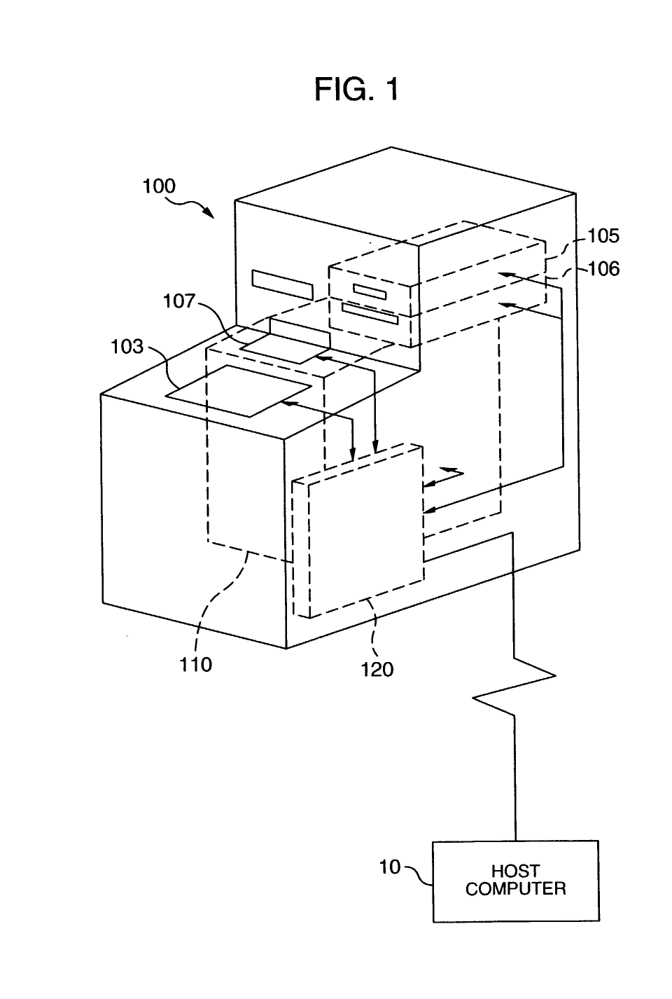

FIG. 1 is an explanatory diagram generally illustrating the configuration of an automatic teller machine which embodies the present invention. The automatic teller machines are installed in financial institutions such as banks for executing money receiving and paying processing in response to a manipulation of a user without the assistance of attendants.

The automatic teller machine (hereinafter called the “ATM”) 100 in this embodiment can support a magnetic card which records a plurality of account numbers. A customer can select an arbitrary account from a plurality of accounts recorded on a single magnetic card for depositing and withdrawing money. The ATM 100 stores bills in a plurality of currency units such as yen, dollar and the like, so that the user can deposit and withdraw money by selecting a currency unit as appropriate. The user is permitted to deposit and withdraw money in a currency unit different from a currency unit designated to an account, for example, the user can deposit and withdraw money in dollar to and from an account which is designated the yen. While a selectable range of currency units of cash received and paid by the ATM is limited to the kinds of currency units of bills stored therein, the ATM can support currency units designated to accounts in a wider range. For example, even when the ATM 100 stores only bills in yen and dollar, the user can deposit and withdraw money to and from a account which is designated the Hong Kong dollar.

To implement such receipt and payment of money, the ATM 100 comprises the following units in an arrangement illustrated in FIG. 1. A card handling mechanism 105 has a function of reading information recorded on a magnetic stripe card such as a so-called cash card. The information recorded on the card includes an account number as account specifying information for identifying an account of a customer, a private identification number, and the like. When a customer has a plurality of accounts, a plurality of account numbers are read from a card. Alternatively, the user may sequentially input a plurality of candidate accounts. For example, a plurality of magnetic cards, each of which records a single account number, may be read one by one, or account numbers may be inputted by the user one by one from a touch panel or the like. However, a plurality of accounts may be collectively read from a magnetic card, so that the user can be less burdened with the input manipulation to improve the user-friendliness of the ATM 100.

A manipulation unit 103 is an interface for displaying information associated with deposit and withdrawal transactions and for the user to manipulate thereon for depositing and withdrawing money. In this embodiment, a touch panel is used, but the manipulation unit 103 may be made up of a display, push buttons, and the like in combination.

The user feeds and receives bills through a bill receipt/payment port 107. For depositing, bills fed by the user into the bill receipt/payment port 107 are classified by a built-in bill handler 110 in accordance with the denomination for custody. For withdrawing, the bill handler 110 prepares bills of an amount specified by the user, and delivers the bills to the user through the bill receipt/payment port 107. The bill handler 110 can store bills in a plurality of money units separately from one another. While the kinds of currency units of bills to be stored can be arbitrarily selected, assume in this embodiment that bills in yen and dollar are stored for convenience of description- A detail slip printing mechanism 106 prints a detail slip which records contents of a particular transaction.

The ATM 100 may be provided with a variety of units, not limited to those illustrated herein. For example, the ATM 100 may be provided with a unit for handling a passbook, a unit for handling coins, and the like, in addition to the foregoing units.

The operation of the respective units in the ATM 100 described above is controlled by a control unit 120. The control unit 120 is based on a microcomputer which contains a CPU and a memory. The control unit 120 communicates information with the respective units, as indicated by arrows in FIG. 1, to control the overall operation of the ATM 100. The ATM 100 is connected to a host computer 10 in a financial institution through a communication line. The control unit 120 executes processing involved in receipt and payment of money, while communicating with the host computer 10 as appropriate.

A2. Control Block:

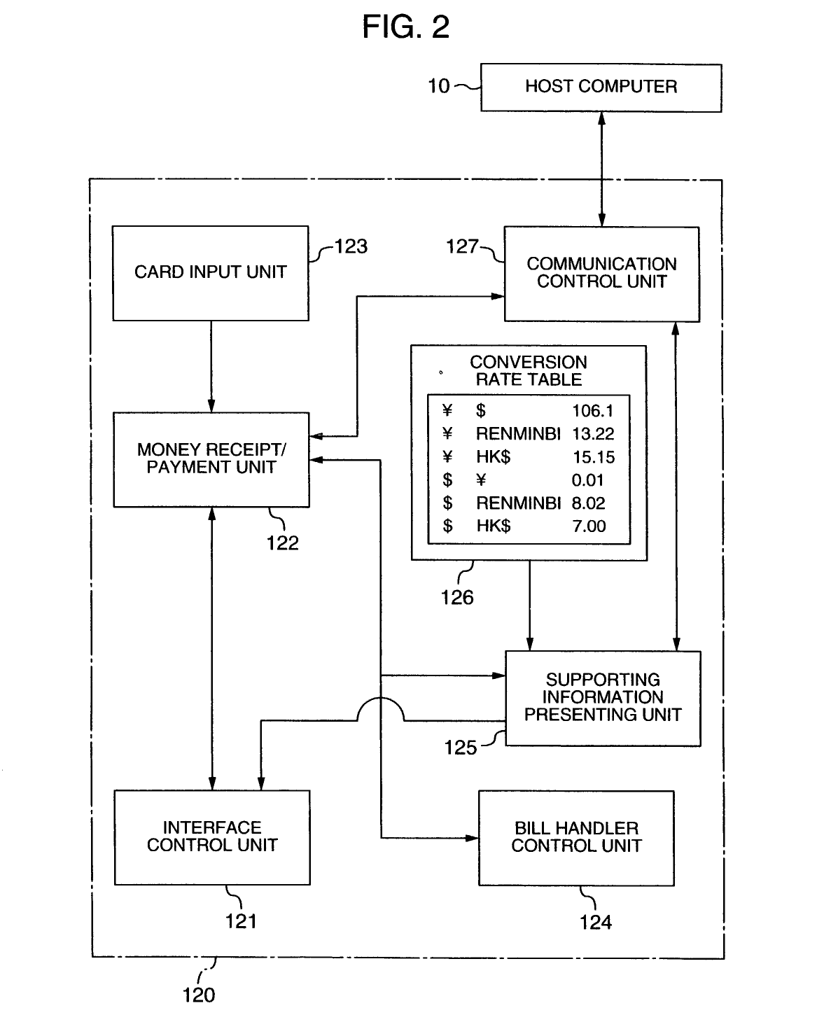

FIG. 2 is an explanatory diagram illustrating functional blocks of the control unit 120. While in this embodiment, respective functional blocks are implemented in software within the control unit 120, they may be implemented in hardware. FIG. 2 only shows functional blocks associated with money receipt/payment processing.

A card input unit 123 controls the card handling mechanism 105 to receive information on a magnetic card. This information includes account numbers assigned to a plurality of accounts used by a customer, and a private identification number. Since a plurality of accounts recorded thereon are candidates for an account with which the customer intends to deposit or withdraw money, the plurality of accounts are hereinafter called the “candidate accounts.” The information inputted from the magnetic card is passed to a money receipt/payment unit 122 which controls the overall money receipt/payment processing.

Supporting information presenting unit 125 has a function of presenting the user with supporting information which serves as a determination material for the user to select an account for deposit or withdrawal from a plurality of accounts included in a card. The supporting information presenting unit 125 receives account numbers of candidate accounts from the money receipt/payment unit 122, and prepares supporting information corresponding to each account. The supporting information is displayed on the touch panel through an interface control unit 121.

In this embodiment, the supporting information presenting unit 125 provides, as the supporting information, an interest rate, balance, currency unit, and conversion rates to other currency units for each account. The supporting information can be arbitrarily set, and may include, for example, past transaction particulars such as transfer, automatic deduction and the like from the account, changes in conversion rates, and the like.

In this embodiment, the supporting information includes information such as the balance of an account which cannot be determined only by the ATM 100. The supporting information presenting unit 125 communicates with the host computer 10 through a communication control unit 127 to acquire the information. Information independent of accounts, for example, conversion rates is presented with reference to a previously provided conversion rate table 126. Contents of the conversion rate table are illustrated in FIG. 2. The conversion rate table stores conversion rates of currency units “yen (¥)” and “dollar ($)”, which may be received and paid in the ATM 100, to a variety of available currency units. In this embodiment, the conversion rate table individually provides conversion rates in accordance with converting directions, such as a conversion rate from “yen” to “dollar”, a conversion rate from “dollar” to “yen,” and the like, in consideration of simplification and promptitude of conversion processing. Alternatively, the conversion rates may be provided only in one direction.

Advantageously, the conversion rate table 126 provided beforehand can rapidly present a conversion rate without relying on a communication with the host computer 10. However, since conversion rates vary over time, the conversion rate table 126 can be preferably updated as required through communications with the host computer 10.

Alternatively, the conversion rate table 126 may be omitted, in which case conversion rates may be acquired through communications with the host computer 10. This strategy is advantageous in that the latest conversion rates can be uniformly presented from the host computer 10.

A bill handler control unit 124 controls the bill handler 110. For a payment, the control unit 124 outputs the amount of money to be paid, the associated currency unit, and the like to the bill handler 110 based on an instruction from the money receipt/payment unit 122. For a receipt, the control unit 124 acquires the amount of received money, the associated currency unit, and the like from the bill handler 110, and passes this information to the money receipt/payment unit 122.

The interface control unit 121 controls the manipulation unit 103 implemented by a touch panel to display supporting information and input an account associated with receipt or payment of money, the amount of money, and the like. The inputted information is passed to the money receipt/payment unit 122. The money receipt/payment unit 122 performs the currency unit conversion processing and the like as appropriate, and transmits the resulting information to the host computer 10 through the communication control unit 127 for money receipt/payment processing. For a payment, the interface control unit 121 additionally communicates information such as the amount of money to be paid, and the associated currency unit to the bill handler control unit 124.

A3. Payment Processing:

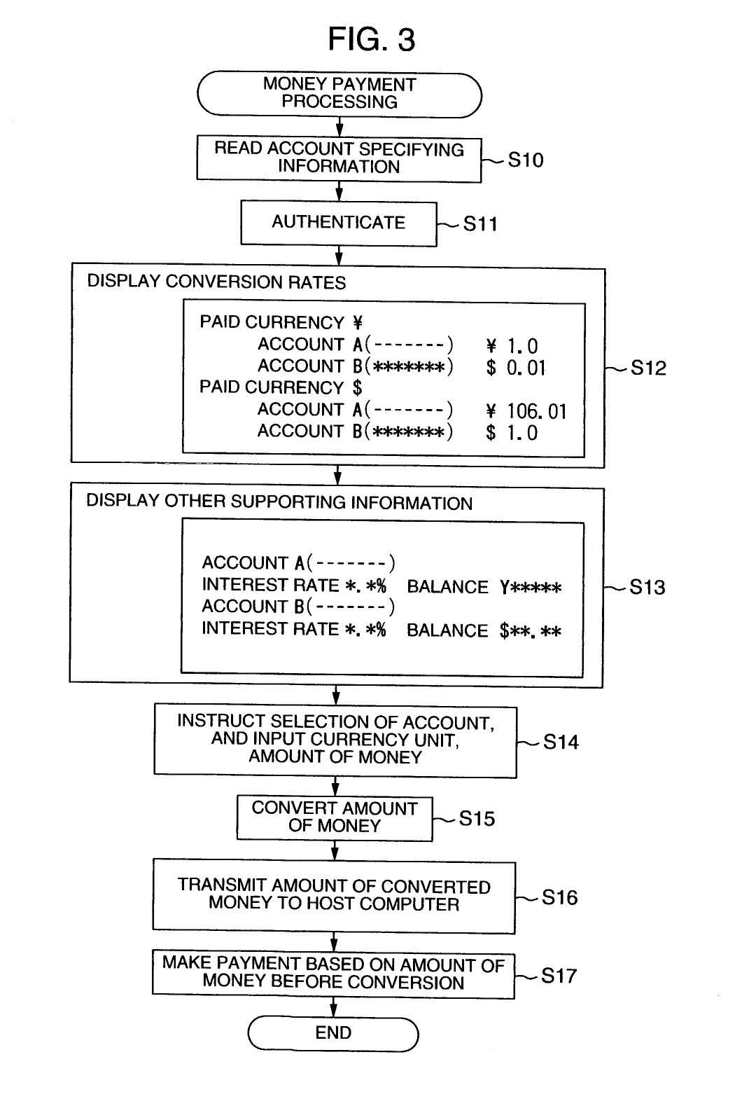

FIG. 3 is a flow chart illustrating the payment processing. This is the processing executed by the control unit 120 for paying money in a currency unit selected by the user from preferred accounts selected by the user within a plurality of candidate accounts. This processing is started when the user selects “WITHDRAW” from a menu displayed on the touch panel of the ATM 100.

As the processing is started, the control unit 120 reads account specifying information from a magnetic card (step S10). At this time, account numbers of a plurality of candidate accounts are inputted to the control unit 120. Assume herein that two types of accounts, i.e., an account A in “yen” and an account B in “dollar” are included in the candidate accounts. Next, the control unit 120 authenticates the user with an inputted personal identification number or the like (step S11).

The control unit 120 displays supporting information for the candidate accounts. Here, the supporting information is divided into conversion rates and other supporting information which are displayed in steps. First, the control unit 120 displays conversion rates (step S12). An exemplary display of conversion rates on the touch panel is illustrated in FIG. 3. Since the ATM 100 can pay in yen and dollar, conversion rates from the candidate accounts A, B are displayed for each of these currency units. As information useful in paying in yen (¥), the control unit 120 displays that the account A (account indicated by the account number in parenthesis) is a yen (¥) based account, the conversion rate of which is 1.0. The control unit 120 displays that the account B is a dollar ($) based account, the conversion rate of which is 0.01. Information useful when a payment is made in dollar ($) is also displayed in a similar format. While in this embodiment, the control unit 120 presents information for each of currency units in which a payment is made, the control unit 120 may display, for each account, information useful when a payment is made in yen and information useful when a payment is made in dollar. Also, changes in the conversion rates may be presented in combination with the conversion rates. By estimating a conversion rate based on its change, the user can determine profits or losses possibly caused by a selection of an account.

Next, the control unit 120 displays other supporting information (step S13). In this embodiment, the control unit 120 displays the interest rate and balance for each of the candidate accounts. The control unit 120 communicates with the host computer 10 as necessary to acquire such information for display. An exemplary display of the supporting information on the touch panel is illustrated in FIG. 3. Information which relatively lightly depends on accounts, such as the interest rate, may be previously stored in the control unit 120. The control unit 120 indicates the account number in parenthesis as well as displays the interest rate and balance, as the supporting information, for each of the candidate accounts. The balance is indicated in a currency unit designated to each account. Based on the displayed information, the user can determine profits and losses possibly caused by a selection of an account, for example, by selecting an account such that a larger balance is held in an account which has a higher interest rate.

The control unit 120 inputs a payment instruction from the user (step 14). The payment instruction includes an instruction of selecting an account from which a payment is made, the currency unit of money to be paid, and the amount of money. For example, the control unit 20 inputs an instruction that ten dollars are paid from the account A.

As the amount of money is inputted, the control unit 120 converts the amount of money (step S15), and transmits the converted amount of money to the host computer 10 (step S16). Assume, for example, that ten dollars are paid from the account A. Since the account A is a yen-based account, the control unit 120 must convert the amount of money to be paid from dollar to yen before it executes account balance processing. Therefore, the control unit 120 converts ten dollars to yen at a conversion rate retrieved from the conversion table 125, and transmits this amount of money to the host computer 10 as the amount of money to be paid. Alternatively, the conversion can be made in the host computer 10 as well. In this event, the control unit 120 omits the processing at step S15, and only needs to transmit the amount of money to be paid in dollar to the host computer 10.

The amount of money converted to the currency unit designated to the account A is preferably displayed on the touch panel together with the amount of money inputted by the user at step S14. In this event, the conversion rate used to calculate the amount of money is preferably displayed together. In this way, the user can confirm the amount of money actually withdrawn from the account A, and the validity therefor.

In addition to the communication to the host computer 10, the control unit 120 makes a payment based on the amount of money before the conversion (step S17). In other words, the control unit 120 instructs the bill handler 110 to pay ten dollars. With the foregoing processing, the user can withdraw a desired amount of cash from an arbitrary account in a desired currency unit (dollar in this case).

A4. Money Receipt Processing:

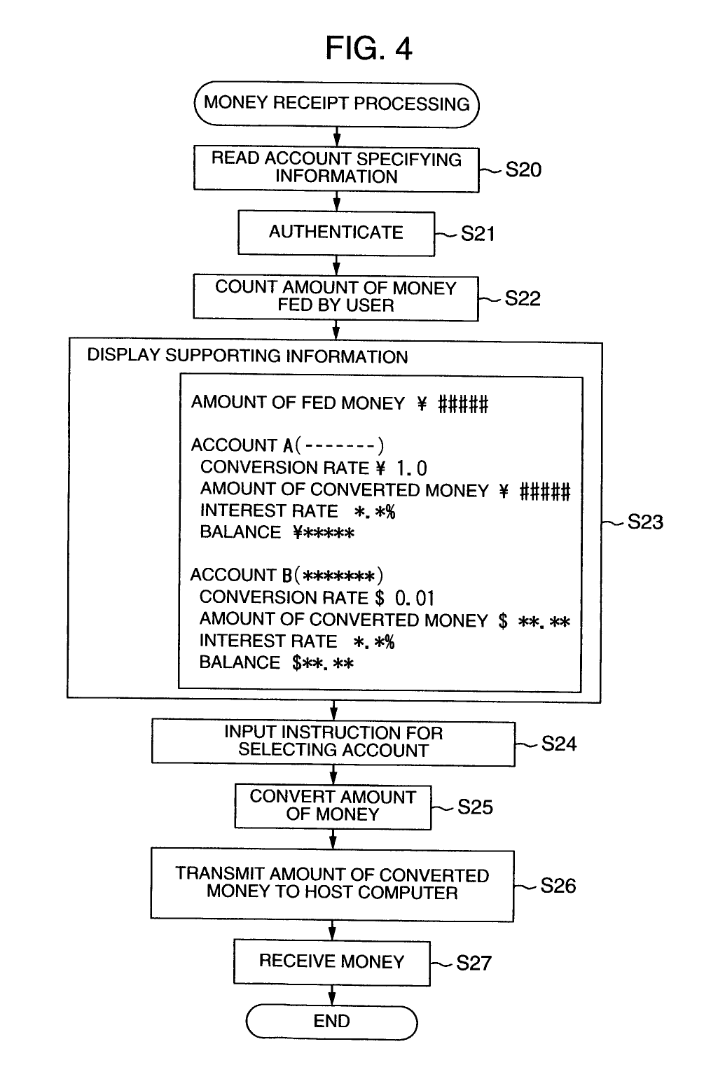

FIG. 4 is a flow chart of the money receipt processing. This is the processing executed by the control unit 120 for depositing money in a preferred account selected by the user from a plurality of candidate accounts in a currency unit selected by the user. This processing is started when the user selects “DEPOSIT” from the menu displayed on the touch panel of the ATM 100.

As the processing is started, the control unit 120 reads account specifying information from a magnetic card or the like (step S20), and authenticates the user (step S21).

Next, the control unit 120 controls the bill handler 110 to count the amount of bills fed by the user (step S22). The bill handler 110 identifies the amount of money to be deposited and a currency unit thereof, and communicates this information to the control unit 120.

The control unit 120 displays supporting information based on the communicated information as a material for determining an account to be selected for deposit (step S23). An exemplary display of the supporting information is illustrated in FIG. 4. In this embodiment, the control unit 120 displays the amount of received money, a conversion rate, the amount of converted money, an interest rate, and the balance for each account. In this example, bills are received in yen (¥). The supporting information also indicates that the account A (account identified by an account number in parenthesis) is a yen-based account, and a conversion rate for the amount of received money is 1.0. The amount of converted money refers to the amount of received money converted at this conversion rate. The balance displayed as the supporting information may be either the balance before the deposit or the balance which is reached when supposing that the amount of money is added thereto. In addition to them, the supporting information may display changes in conversion rates, past transaction particulars, and the like. The user can determine profits and losses possibly caused by a selection of an account, based on the supporting information, to select an account.

The control unit 120 inputs the result of selection, i.e., an instruction to select an account to which money is deposited (step S24), converts the amount of money as appropriate (step S25), and transmits the amount of converted money to the host computer 10 (step S26). Similarly to the payment processing, the conversion may be made in the host computer 10. Also, the amount of converted money may be again presented to the user. In this event, the conversion rate may be presented together.

The control unit 120 controls the bill handler 110, in addition to the foregoing processing, to receive bills (step S27). In response to this control instruction, the bill handler 110 classifies the fed bills in accordance with the denomination for separate storage in corresponding depositories.

A5. Effects:

According to the ATM 100 in the first embodiment described above, the user can flexibly deposit and withdraw money to and from a plurality of accounts in a plurality of currency units. In this event, since the user is provided with the supporting information which serves as a determination material for the user to select an account and currency unit, the user can select an account and a currency unit in consideration of profits and losses.

B. Second Embodiment:

The first embodiment has illustrated an ATM installed in a financial institution to which the present invention is applied. The present invention can also be applied to the money receipt/payment processing which does not involve the receipt/payment of cash such as a transfer from one account to another. While such transfer processing may be incorporated in the first embodiment as one function of the ATM, it can be implemented in the form of so-called online banking which utilizes network communication technologies such as the Internet. In the following, a second embodiment will be shown as an example to which the present invention is applied, where a transfer is conducted in the form of online banking.

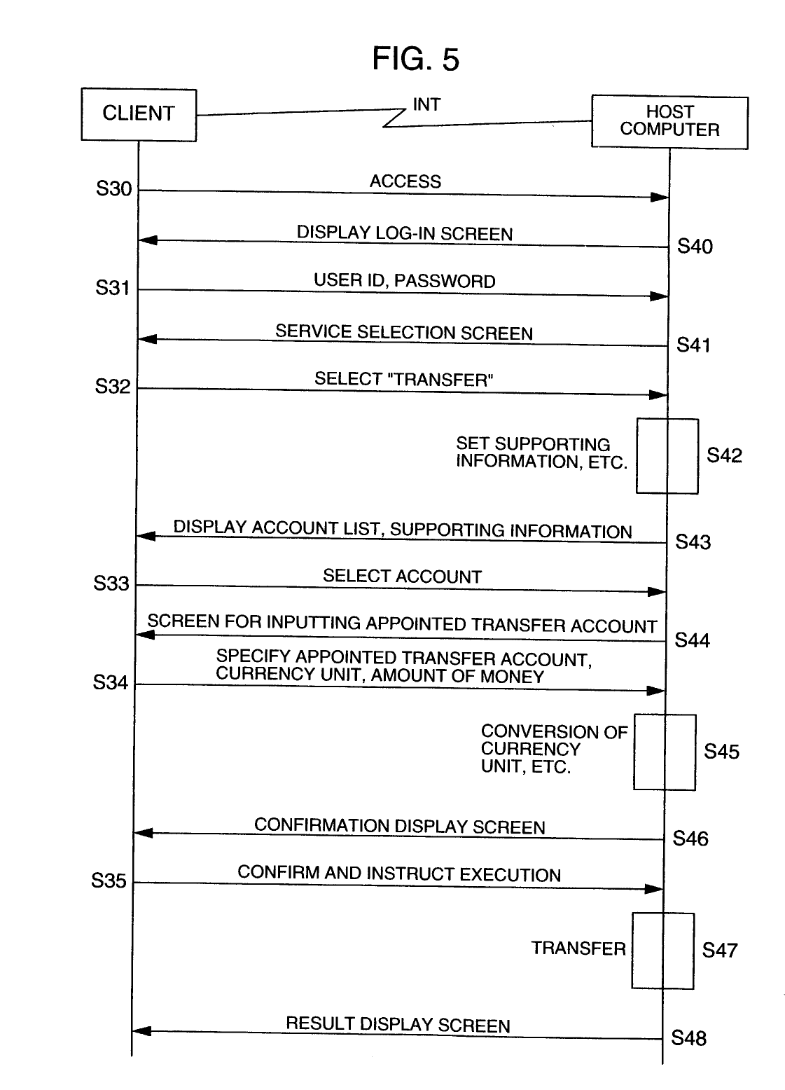

FIG. 5 is a flow chart illustrating processing steps involved in a transfer in the second embodiment. In an upper portion of the figure, a system configuration is illustrated as the basis of the processing. A system considered in the second embodiment comprises a host computer in a financial institution and a client computer of the user, which are interconnected through the Internet INT. The client computer has installed therein a browser which is software for viewing files in HTML (Hyper Text Markup Language) format and the like transmitted from the host computer. The browser can display an interface screen for inputting/outputting information available in the money receipt/payment processing based on data transmitted from the host computer.

As the user starts the browser to access URL (Uniform Resource Locator) of the host computer (step S30), the host computer displays a log-in screen in response (step S40). The user logs in the system by transmitting the user ID, password and the like (step S31). The host computer can identify one or a plurality of candidate accounts available to the user, based on the user ID. In this sense, the input of user ID may be a manipulation corresponding to the reading of a magnetic card in the first embodiment. As the host computer successfully authenticates the user, a service selection screen is displayed (step S41). Assume herein that the user selects “TRANSFER” (step S32).

The host computer sets a list of candidate accounts available for a transfer, and supporting information (step S42), and presents them to the user (step S43). The contents of this information and a method of presenting the same may take a form similar to, for example, the payment processing (FIG. 3) in the first embodiment.

As the user selects an account based on the presented information (step S33), the host computer displays a screen for the user to input an appointed transfer account (step S44). As the user specifies an appointed transfer account, a currency unit in a transfer, and the amount of money (step S34), the host computer converts the currency unit as required (step S45), and displays a confirmation display screen (step S46). This screen displays an account utilized in the transfer, the appointed transfer account, the amount of transferred money, and the sum of the amount of transferred money and a commission converted to the currency unit of the account.

As the user confirms details on the transfer and instructs the execution of the transfer on the screen (step S35), the host computer performs processing involved in the transfer (step S47) and displays the result (step S48).

As appreciated from the foregoing, the second embodiment also permits the user to make transactions with a plurality of accounts in a plurality of currency units, as is the case with the first embodiment. In addition, with the presentation of the supporting information, the user can determine profits and losses involved in a selection of a currency unit.

C. Exemplary Modifications:

In the first and second embodiments, the user is permitted to select one from a plurality of accounts in one of a plurality of currency units. Alternatively, the user may be permitted to select either an account or a currency unit from a plurality of candidates. For example, the user may be permitted to select one from a plurality of accounts under a situation where only one currency unit is applied. In this case, it is possible to improve the convenience in selecting an account by presenting the user with supporting information such as an interest rate, balance, and the like, which is not associated with the currency unit. Conversely, the user may be permitted to select one from a plurality of currency units for a single account. In this case, it is possible to improve the convenience in selecting a currency unit by presenting the user with supporting information associated with a conversion of a currency unit to another, such as conversion rates, changes in the conversion rates, and the like.

While the foregoing embodiments have shown two candidate accounts which are different in currency unit from each other, candidate accounts may include those which are common in currency unit. Also, while in the foregoing embodiments, the currency units designated to candidate accounts are the same as those which can be supported by the ATM 100, candidate accounts may include those accounts which are designated currency units that cannot be supported by the ATM 100. This is because the currency units which can be supported by the ATM 100 are merely restrictions imposed on the receipt and payment of cash. For example, a Hong Kong dollar based account may be included in candidate accounts in the ATM 100 of the embodiments which permits the user to deposit and withdraw yen and dollar. This is because the processing shown in the embodiments is not hindered as long as the ATM 100 has conversion rates between yen, dollar and the like and Hong Kong dollar.

The following summarizes principal features of the present invention described above.

As a first configuration, the present invention provides an automatic money receiving and paying machine for receiving or paying money to or from an account in response to a manipulation of the user, wherein the automatic money receiving and paying machine can handle a plurality of accounts, and presents the user with supporting information for selecting an account. For this purpose, the automatic money receiving and paying machine of the present invention comprises an account input unit, a supporting information presenting unit, a selection instruction input unit, an amount input unit, and a money receipt/payment unit in its first configuration.

The account input unit is provided for inputting account specifying information for a plurality of candidate accounts. The account specifying information refers to information for specifying an account with which the user intends to deposit or withdraw money, and includes an account number, for example. The candidate accounts are not necessarily those accounts which are designated different currency units, but may be those accounts which are designated a single currency unit.

The supporting information presenting unit presents supporting information to the user. The supporting information refers to such information that help the user select a single preferred account with which the user intends to deposit or withdraw money, from a plurality of candidate accounts. The supporting information presenting unit may collectively present the supporting information for all candidate accounts, or sequentially presents the supporting information for each candidate account in response to a manipulation of the user. When the supporting information includes a plurality of types of information, the supporting information presenting unit may collectively present them or present them in stages.

The selection instruction input unit is provided to input the result of a selection for a preferred account, made by a user, i.e., a selection instruction. The amount input unit in turn is provided to input the amount of money to be deposited or withdrawn. For a deposit, the amount input unit may input the amount of money by counting a cash fed into the automatic money receiving and paying machine by the user.

The money receipt/payment unit executes money receipt/payment processing with a preferred account in accordance with the amount of money inputted by the money input unit. In this specification, the money receipt/payment means overall processing involved in incomings and outgoings of money to and from accounts, and includes a payment from an account, a deposit to an account, a transfer from one account to another account, and the like. Money receipt/payment processing means a sequence of processing involved in receipt and payment of money, and includes, for example, custody of cash in the automatic money receiving and paying machine, processing for recording the amount of received money on an account, entry into a passbook, printing of a detail slip, and the like in regard to receipt of money. When the automatic money receiving and paying machine is installed separately from a host computer for managing accounts, accounts are recorded when the automatic money receiving and paying machine transmits data to the host computer. In regard to payment, on the other hand, the money receipt/payment processing includes transportation of cash, processing for recording the amount of paid money on an account, entry into a passbook, printing of a detail slip, and the like. The money receipt/payment processing also includes processing which is not associated with receipt and payment of cash, such as a transfer from an account of the user to another account. In such a case, the money receipt/payment processing includes processing for instructing the amount of transferred money and an appointed transfer account to the host computer, printing of a detail slip, and the like.

According to the first configuration of the present invention, the user can select one preferred account from a plurality of candidate accounts for proceeding to deposit or withdrawal. In this event, since the user is presented with the supporting information, the user can select a preferred account in consideration of profits and losses of each account possibly resulting from the selection, thereby improving the convenience of the automatic money receiving and paying machine.

In the first configuration, while the user may sequentially input the account specifying information for a plurality of candidate accounts, such information is preferably inputted by reading a magnetic card which records account specifying information for a plurality of accounts. This helps the user input the account specifying information for a plurality of accounts, so that the automatic money receiving and paying machine can provide a more improved convenience.

In the first configuration, when the automatic money receiving and paying machine is connected to the host computer for managing accounts through a predetermined communication line, the supporting information may be acquired by a communication with the host computer. In this way, the automatic money receiving and paying machine can acquire the latest information, individual information corresponding to each account, and the like from the host computer, so that practical supporting information can be presented to the user.

Alternatively, the automatic money receiving and paying machine may present the user with supporting information previously stored therein. Advantageously, in this case, information can be rapidly presented because no communication with the host computer is required for presenting the supporting information.

In the first configuration, a variety of information can be applied to the supporting information. For example, the supporting information can include at least one of an interest rate, transaction particulars, and the balance for each account. When the interest rate is used as the supporting information, the user can select an account with a lower interest rate for withdrawing money, and select an account with a higher interest rate for depositing money. The transaction particulars refer to past particulars associated with deposits and withdrawals of money. When the transaction particulars are used as the supporting information, the user can readily identify, for example, an account from which public utility charges are debited, an account utilized for transfers in the past, and the like, so that the user can readily select accounts for depositing money committed to them. When the balance is used as the supporting information, the user can select accounts for deposit and withdrawal to make the balances as uniform as possible, or can select an account for deposit and withdrawal such that a larger balance remains in an account with a higher interest rate.

When accounts designated different currency units are mixed in candidate accounts, the supporting information can include, for example, at least one of a currency unit, conversion rates to other currency units, and changes in the conversion rates for each account. With such information presented to the user as the supporting information, the user can select an account in consideration of profits and losses possibly caused by a desired currency unit and conversion rate. Other than those illustrated above, a variety of information can be applied to the supporting information.

In a second configuration, the present invention provides an automatic money receiving and paying machine which is capable of handling a plurality of currency units, wherein information is presented to the user to select a currency unit in which the user deposits or withdraws money. For this purpose, the automatic money receiving and paying machine in the second configuration comprises a depository for holding a plurality of kinds of currencies, an account input unit, a conversion rate presenting unit, an instruction input unit, and a money receipt/payment unit. The account input unit is provided to inputting account specifying information which may include a plural number of pieces of information or a single piece of information.

The conversion rate presenting unit presents the user with conversion rates of a currency unit designated to an account to respective currency units stored in the depository. When a plurality of accounts exist, the conversion rate presenting unit presents such conversion rates for each of the accounts.

The instruction input unit is provided to input the amount of money to be received or paid, and a currency unit. The money receipt/payment unit executes money receipt/payment processing from an account in accordance with an inputted amount of money and currency unit. While the money receipt/payment processing is similar to that in the first configuration, a conversion of currency unit is included as required in the second configuration. Consider that the automatic money receiving and paying machine is installed separately from a host computer for managing accounts. Irrespective of a currency unit in which the user actually deposits or withdraws money, the deposit and withdrawal are eventually recorded in a currency unit associated with a particular account, so that the conversion of currency unit is required. In such a case, the money receipt/payment processing in the second configuration includes the conversion of currency unit which may be executed by either the automatic money receiving and paying machine or the host computer.

According to the second configuration, the user can convert a currency unit designated to an account to a desired currency unit before withdrawing money from the account. In this event, since the conversion rate is presented to the user, the user can select a currency unit in which the user withdraws money in consideration of profits and losses and the like possibly caused by the conversion.

Preferably, in the second configuration, changes in conversion rates are additionally presented on the conversion rate presenting unit. The user can estimate future fluctuations in the conversion rates based on their changes for utilization in selecting a currency unit in which the user intends to withdraw money. In the second configuration, the conversion rate can be provided in a variety of ways.

For example, a conversion rate storage unit may be provided for storing a conversion rate in combination of a currency unit designated to an available account with a currency unit of deposited money, such that the conversion rate presenting unit presents the conversion rate based on the stored value. Advantageously, this can promptly present the conversion rate without the need for a communication to the outside. Preferably, the conversion rate storage unit can be updated on a periodic basis, for example, once a day.

When the automatic money receiving and paying machine is connected to a host computer for managing accounts through a predetermined communication line, a conversion rate may be acquired through a communication with the host computer for providing the conversion rate to the user. Advantageously, this can provide the latest conversion rate.

The present invention can also provide an automatic money receiving and paying machine which is made up of the first configuration and second configuration in combination. Specifically, an automatic money receiving and paying machine capable of handling a plurality of accounts and a plurality of currency units presents the user with supporting information for supporting the user to select an account, as well as a conversion rate and the like for supporting the user to select a currency unit in which the user intends to withdraw money. In this configuration, the user can totally consider profits and losses possibly caused by a selection of an account and a currency unit for depositing and withdrawing money to improve the convenience of the automatic money receiving and paying machine.

The present invention can be implemented in a variety of manners without limited to the foregoing automatic money receiving and paying machines. For example, present invention may be implemented as a control method for controlling the operation of an automatic money paying and receiving machine to receive and pay money to and from an account in response to a manipulation of the user. The present invention can also be implemented as a computer program for causing a computer connected to a host computer for managing accounts through a communication line to receive and pay money to and from an account in response to a manipulation of the user. Since the money receipt/payment processing also includes a transaction which does not necessarily involve give-and-take of cash, such as a transfer, the computer program may include a program executed by a so-called commercially available computer. For example, the present invention may be implemented as a program for receiving and paying money through an interface displayed by a browser on a commercially available computer connected to a host computer of a bank through the Internet.

The present invention may be implemented by a storage medium which stores the foregoing computer programs. The storage medium herein referred to may include a flexible disk, a CD-ROM, a magneto-optical disk, an IC card, a ROM cartridge, a punch card, a printed matter on which codes such as a bar code is printed, and a variety of computer readable media such as internal storage devices of a computer (memories such as RAM, ROM and the like), external storage devices, and the like.

While the present invention has been described in connection with a variety of embodiments, it should be understood that the present invention is not limited to those embodiments but may take a variety of configurations without departing from the spirit and scope of the invention.

According to the present invention, the user can select a preferred account from a plurality of candidate accounts for depositing or withdrawing money. In this event, since the user is presented with supporting information, the user can select a preferred account in consideration of profits and losses of each account possibly caused by the selection of the account, thereby making it possible to improve the convenience of the automatic money receiving and paying machine. In addition, according to the present invention, the user can convert a currency unit designated to an account to a desired currency unit for withdrawing money. In this event, since the conversion rate is presented to the user, the user can select a currency unit in which the user intends to withdraw money in consideration of profits and losses, and the like possibly caused by the conversion.

What is claimed is:

1. An automatic money receiving and paying machine for receiving and paying money from an account in response to a manipulation of a user, comprising:
an account input unit for inputting account specifying information, for specifying an account with which the user deposits or withdraws money, for a plurality of candidate accounts;
supporting information presenting unit for presenting the user with supporting information for supporting the user to select from said plurality of candidate accounts a preferred account with which the user deposits or withdraws money;
a selection instruction input unit for inputting an instruction to select said preferred account;
an amount input unit for inputting an amount of money to be deposited or withdrawn; and
a money receipt/payment unit for executing money receipt/payment processing with said preferred account in accordance with the inputted amount of money.

2. An automatic money receiving and paying machine according to claim 1, wherein:
said account input unit reads a magnetic card which records account specifying information for a plurality of accounts to input the account specifying information.

3. An automatic money receiving and paying machine according to claim 1, wherein said automatic money receiving and paying machine is connected to a host computer for managing said account through a predetermined communication line,
wherein said supporting information presenting unit acquires said supporting information through a communication with said host computer.

4. An automatic money receiving and paying machine according to claim 1, wherein:
said supporting information includes at least one of an interest rate, transaction particulars, and the balance for each account.

5. An automatic money receiving and paying machine according to claim 1, wherein:
said candidate accounts include accounts which are designated different currency units, and said supporting information includes at least one of a currency unit of each account, conversion rates to other currency units, and changes in the conversion rates.

6. An automatic money receiving and paying machine for receiving and paying money from an account in response to a manipulation of a user, comprising:
a depository for holding a plurality of kinds of currencies;
an account input unit for inputting account specifying information for specifying an account with which the user deposits or withdraws money;
a conversion rate presenting unit for presenting the user a conversion rate of a currency unit designated to said account to each of the currency units held in said depository;
an instruction input unit for inputting an amount of money to be deposited or withdrawn, and a currency unit; and
a money receipt/payment unit for executing money receipt/payment processing with said preferred account in accordance with the inputted amount of money and currency unit.

7. An automatic money receiving and paying machine according to claim 6, wherein:
said conversion rate presenting unit further presents a change in the conversion rate.

8. An automatic money receiving and paying machine according to claim 6, further comprising:
a conversion rate storage unit for storing said conversion rate in combination of a currency unit handled by an available account with each of said held currency units,
wherein said conversion rate presenting unit presents the conversion rate with reference to said conversion rate storage unit.

9. An automatic money receiving and paying machine according to claim 8, wherein:
said automatic money receiving and paying machine is connected to a host computer for managing said account through a predetermined communication line,
wherein said conversion rate presenting unit presents the conversion rate through a communication with said host computer.

10. A control method for controlling an operation of an automatic money receiving and paying machine for receiving and paying money from an account in response to a manipulation of a user, said method comprising the steps of:
inputting account specifying information, for specifying an account with which the user deposits or withdraws money, for a plurality of candidate accounts;
presenting the user with supporting information for supporting the user to select a preferred account with which the user deposits or withdraws money from said plurality of candidate accounts;
inputting an instruction to select said preferred account;
inputting an amount of money to be deposited or withdrawn; and
executing money receipt/payment processing with said preferred account in accordance with the inputted amount of money.

11. A control method for controlling an operation of an automatic money receiving and paying machine comprising a depository for holding a plurality of kinds of currencies, for receiving and paying money to and from an account in response to a manipulation of a user, said method comprising:
inputting account specifying information for specifying an account with which the user deposits or withdraws money;
presenting the user with a conversion rate of a currency unit designated to said account to each of the currency units held in said depository;
inputting an amount of money to be deposited or withdrawn, and a currency unit; and
executing money receipt/payment processing with said preferred account in accordance with the inputted amount of money and currency unit.

12. A computer program for causing a computer connected to a host computer for managing accounts through a communication line to receive and pay money to and from an account in response to a manipulation of a user, said computer program comprising:
a function of inputting account specifying information, for specifying an account with which the user deposits or withdraws money, for a plurality of candidate accounts;
a function of presenting the user with supporting information for supporting the user to select a preferred account, with which the user deposit or withdraw money, from said plurality of candidate accounts;
a function of inputting an instruction to select said preferred account;
a function of inputting an amount of money to be deposited or withdrawn; and
a function of executing money receipt/payment processing with said preferred account in accordance with the inputted amount of money.

13. A computer program for causing a computer connected to a host computer for managing accounts through a communication line to receive and paying money to and from an account in response to a manipulation of a user, said computer program comprising:
a function of inputting account specifying information for specifying an account with which the user deposits or withdraws money;
a function of presenting the user with a conversion rate of a currency unit designated to said account to each of the currency units which can be specified for the deposit or withdrawal of money;
a function of inputting an amount of money to be deposited or withdrawn, and a currency unit; and
a function of executing money receipt/payment processing with said preferred account in accordance with the inputted amount of money and currency unit.
